(19) United States
(12) Patent Application Publication
(10) Pub. No.: US 2023/0289401 A1
(43) Pub. Date: Sep. 14, 2023

(54) SOLUTION ACCURACY GUARANTEEING ANNEALING CALCULATION DEVICE, METHOD, AND PROGRAM

(71) Applicant: NEC Corporation, Minato-ku, Tokyo (JP)

(72) Inventors: Hiroaki Inoue, Tokyo (JP); Takuya Araki, Tokyo (JP); Motoi Suzuki, Tokyo (JP); Fumiyo Takano, Tokyo (JP); Yuki Kobayashi, Tokyo (JP); Hiroshi Chishima, Tokyo (JP); Akihiro Yatabe, Tokyo (JP); Takahiro Nishimura, Tokyo (JP)

(73) Assignee: NEC Corporation, Minato-ku, Tokyo (JP)

(21) Appl. No.: 18/013,416

(22) PCT Filed: Jul. 3, 2020
(86) PCT No.: PCT/JP2020/026164

§ 371 Date: Dec. 28, 2022

(51) Int. Cl. G06F 17/18

(52) U.S. Cl. CPC G06F 17/18

(57) ABSTRACT

A solution accuracy guaranteeing annealing calculation device includes a first solving unit which solves a combinatorial optimization problem by an annealing method, and a second solving unit which solves a relaxation problem, which is a problem generated by relaxing constraints imposed on the combinatorial optimization problem, wherein the second solving unit calculates, if the combinatorial optimization problem is a minimization problem, a lower bound of a minimization target in the minimization problem by solving the relaxation problem generated from the combinatorial optimization problem, and calculates, if the combinatorial optimization problem is a maximization problem, an upper bound of a maximization target in the maximization problem by solving the relaxation problem generated from the combinatorial optimization problem.

### TECHNICAL FIELD

The present invention relates to a solution accuracy guaranteeing annealing calculation device, a solution accuracy guaranteeing annealing calculation method, and a solution accuracy guaranteeing annealing calculation program.

### BACKGROUND ART

The practical application of quantum annealing machines has triggered renewed interest in a study on combinatorial optimization problems. Combinatorial optimization problems are problems of finding optimal combinations. Examples of combinatorial optimization problems include the traveling salesman problem, the knapsack problem, and the graph partitioning problem.

Solvers which are means solving combinatorial optimization problems include, for example, an annealing machine and an integer programming solver. An annealing machine is a solver that solves a problem by taking an appropriate candidate solution as an initial state and changing the state by some rule to finally reach a neighborhood of the optimal solution.

Annealing machines include, for example, simulated annealing machines, quantum annealing machines, and non-quantum annealing machines based on heuristics algorithms.

Patent Literature (PTL) 1 also describes an optimization problem calculation system that includes an Ising machine that calculates the combination of values of variables that minimizes the value of the objective function by simulated annealing using digital circuitry.

An integer programming solver is a solver that solves combinatorial optimization problems by formulating them into integer programming problems. PTL 2 describes a scheduler generating device including an integer programming solver that generates a scheduler by integer programming using a target function and predetermined constraints.

### CITATION LIST

### Patent Literature

PTL 1: Japanese Patent Application Laid-Open No. 2020-004387
PTL 2: Japanese Patent Application Laid-Open No. 2013-030182

### SUMMARY OF INVENTION

### Technical Problem

Annealing machines are suitable for solving combinatorial optimization problems imposed complex constraints. However, the accuracy of the solutions to combinatorial optimization problems output by annealing machines is generally not guaranteed.

The reason why the accuracy of the solution is not guaranteed is due to a property of the algorithm itself: annealing. Since annealing is a kind of approximate solution method for complex problems, it tries to find the most appropriate solution possible without guaranteeing accuracy.

In other words, when combinatorial optimization problems are solved by annealing, appropriate solutions are obtained for most problems, but less accurate solutions may be obtained for complex problems. PTLs 1-2 does not describe a method to guarantee the accuracy of solutions to combinatorial optimization problems.

Therefore, it is an object of the present invention to provide a solution accuracy guaranteeing annealing calculation device, a solution accuracy guaranteeing annealing calculation method, and a solution accuracy guaranteeing annealing calculation program that can guarantee the accuracy of solutions to combinatorial optimization problems.

### Solution to Problem

A solution accuracy guaranteeing annealing calculation device according to the present invention is a solution accuracy guaranteeing annealing calculation device includes a first solving means which solves a combinatorial optimization problem by an annealing method, and a second solving means which solves a relaxation problem, which is a problem generated by relaxing constraints imposed on the combinatorial optimization problem, wherein the second solving means calculates, if the combinatorial optimization problem is a minimization problem, a lower bound of a minimization target in the minimization problem by solving the relaxation problem generated from the combinatorial optimization problem, and calculates, if the combinatorial optimization problem is a maximization problem, an upper bound of a maximization target in the maximization problem by solving the relaxation problem generated from the combinatorial optimization problem.

A solution accuracy guaranteeing annealing calculation method according to the present invention is a solution accuracy guaranteeing annealing calculation method includes solving a combinatorial optimization problem by an annealing method, solving a relaxation problem, which is a problem generated by relaxing constraints imposed on the combinatorial optimization problem, calculating, if the combinatorial optimization problem is a minimization problem, a lower bound of a minimization target in the minimization problem by solving the relaxation problem generated from the combinatorial optimization problem, and calculating, if the combinatorial optimization problem is a maximization problem, an upper bound of a maximization target in the maximization problem by solving the relaxation problem generated from the combinatorial optimization problem.

A solution accuracy guaranteeing annealing calculation program according to the present invention, causing a computer to execute a first solving process of solving a combinatorial optimization problem by an annealing method, and a second solving process of solving a relaxation problem, which is a problem generated by relaxing constraints imposed on the combinatorial optimization problem, wherein the solution accuracy guaranteeing annealing calculation program causes the computer to calculate, if the combinatorial optimization problem is a minimization problem, a lower bound of a minimization target in the minimization problem by solving the relaxation problem generated from the combinatorial optimization problem, and calculate, if the combinatorial optimization problem is a maximization problem, an upper bound of a maximization target in the maximization problem by solving the relaxation problem generated from the combinatorial optimization problem, in the second solving process.

### Advantageous Effects of Invention

According to this invention, it is possible to guarantee the accuracy of solutions to combinatorial optimization problems.

### BRIEF DESCRIPTION OF DRAWING

FIG. 1 is a block diagram showing an example of the configuration of a solution accuracy guaranteeing annealing calculation device of the example embodiment of the present invention.

FIG. 2 is an explanatory diagram showing a size relationship between the minimum value, the optimal value, and the lower bound for the combinatorial optimization problem, which is a minimization problem.

FIG. 3 is an explanatory diagram showing a size relationship between the maximum value, the optimal value, and the upper bound for the combinatorial optimization problem, which is a maximization problem.

FIG. 4 is an explanatory diagram showing an example of dividing a combinatorial optimization problem by a processing control means 120.

FIG. 5 is an explanatory diagram showing an example of solving a first subproblem by a first processing means 130 and a second processing means 140.

FIG. 6 is an explanatory diagram showing an example of solving a second subproblem by the first processing means 130 and the second processing means 140.

FIG. 7 is an explanatory diagram showing another example of solving the second subproblem by the first processing means 130 and the second processing means 140.

FIG. 8 is a flowchart showing an operation of the minimization problem solving process by the solution accuracy guaranteeing annealing calculation device 100 of this example embodiment.

FIG. 9 is a flowchart showing an operation of the maximization problem solving process by the solution accuracy guaranteeing annealing calculation device 100 of this example embodiment.

FIG. 10 is an explanatory diagram showing an example of a hardware configuration of the solution accuracy guaranteeing annealing calculation device 100 according to the present invention.

FIG. 11 is a block diagram showing an overview of a solution accuracy guaranteeing annealing calculation device according to the present invention.

### DESCRIPTION OF EMBODIMENTS

[Description of Configuration]

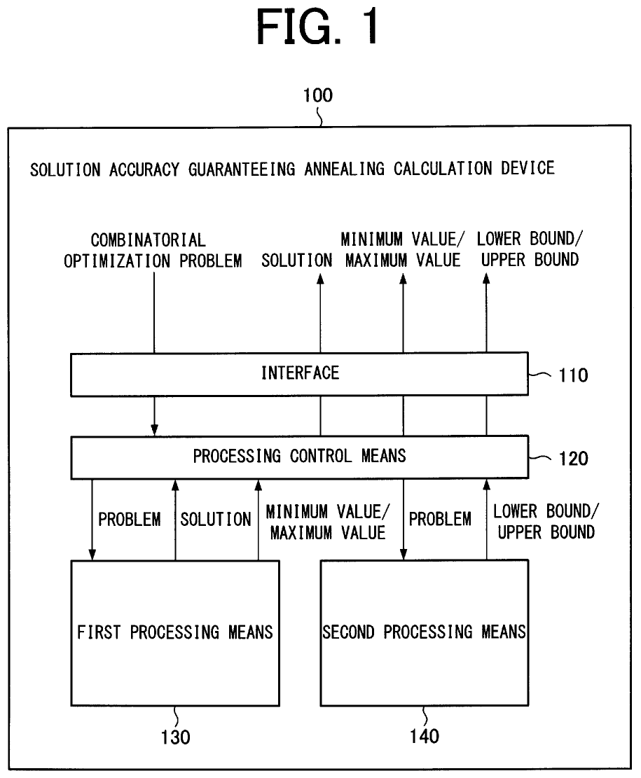

Hereinafter, an example embodiment of the present invention is described with reference to the drawings. FIG. 1 is a block diagram showing an example of the configuration of a solution accuracy guaranteeing annealing calculation device of the example embodiment of the present invention.

As shown in FIG. 1, the solution accuracy guaranteeing annealing calculation device 100 includes an interface 110, a processing control means 120, a first processing means 130, and a second processing means 140.

The unidirectional arrows described in the block diagram indicate the direction in which data (information) flows. However, the possibility of bi-directional data flow is not eliminated at the locations where the arrows are described.

The purpose of the solution accuracy guaranteeing annealing calculation device 100 of this example embodiment is not only to obtain solutions to combinatorial optimization problems imposed complex constraints, but also to guarantee the accuracy of the solutions, by combining an annealing machine and an integer programming solver to solve combinatorial optimization problems.

The integer programming solver described above is only suitable for solving combinatorial optimization problems with simple (linear) constraints such that additivity is satisfied. However, integer programming solvers can output solutions to combinatorial optimization problems with guaranteed accuracy. The reason why the accuracy of the solution is guaranteed is that there is an integer programming solver algorithm that can guarantee the accuracy of the solution under the simple constraint of being linear.

Based on the above contents, when an annealing machine is combined with an integer programming solver to solve a combinatorial optimization problem, it is expected not only to obtain a solution to a combinatorial optimization problem imposed complex constraints, but also to guarantee the accuracy of the solution.

When the accuracy of the solution is guaranteed, the user who requests the solution to a combinatorial optimization problem, for example, can judge the validity of the obtained solution. The user is, for example, a person in charge in a company who wishes to solve a traveling salesman problem with an annealing machine.

As shown in FIG. 1, a combinatorial optimization problem is input to the interface 110. Combinatorial optimization problems are classified as either minimization or maximization problems.

The minimization problem is the problem of finding a combination that minimizes an arbitrary objective function (the minimization target) under given constraints. The maximization problem is the problem of finding a combination that maximizes an arbitrary objective function (the maximization target) under given constraints.

The combinatorial optimization problem of this example embodiment is described, for example, in Ising model form. The Ising model is a statistical mechanical model that represents the behavior of a magnetic material by its individual spins. In the Ising model, the state of each spin is represented by “1” or “−1”.

When the combinatorial optimization problem is represented in Ising model form, the equation representing the energy in the combinatorial optimization problem is first generated. Then, the equation representing the energy in the combinatorial optimization problem is converted to the energy function in the Ising model. The method of conversion to the energy function in the Ising model is well known. The energy function in the Ising model is represented as in the following Equation (1).

[Math. 1]

H_{Ising}=−ΣᵢⱼJᵢⱼsᵢsⱼ−Σᵢhᵢsᵢ Equation (1)

Both i and j in Equation (1) are variables representing spins. Also, sᵢ is a variable representing the state of spin i, and sⱼ is a variable representing the state of spin j in Equation (1).

Also, hᵢ in Equation (1) is a constant corresponding to spin i. For each possible value of i, hᵢ is determined as a constant. Jᵢⱼ in Equation (1) is a constant corresponding to the combination of spin i and spin j. For each possible combination of values of i and j, Jᵢⱼ is determined as a constant.

The energy function in the Ising model may also be a QUBO (Quadratic Unconstrained Binary Optimization) energy function. QUBO is a model that represents the state of each spin by “1” or “0”.

That is, the equation representing the energy in a combinatorial optimization problem can be converted to an energy function in QUBO. This conversion method is well known. Hereafter, a combinatorial optimization problem is said to be described in QUBO form when the equation representing the energy in the combinatorial optimization problem is represented by an energy function in QUBO.

The energy function in the Ising model and the energy function in QUBO are mutually convertible. The energy function in QUBO is expressed as in the following Equation (2).

[Math. 2]

H_{QUBO}=ΣᵢⱼQᵢⱼxᵢxⱼ(x=(s+1)/2) Equation (2)

Both i and j in Equation (2) are variables representing spins. Also, xᵢ in Equation (2) is a variable representing the state of spin i, and xⱼ is a variable representing the state of spin j. Also, Qᵢⱼ in Equation (2) is a constant corresponding to the combination of spin i and spin j. For each possible combination of values of i and j, Qᵢⱼ is determined as a constant.

The combinatorial optimization problem input to the interface 110 may be a problem described in a format other than Ising model form or QUBO form (e.g., transverse magnetic field Ising model form).

The first processing means 130 has the function of solving a combinatorial optimization problem in a state on which complex constraints are imposed by an annealing method. For example, when solving a combinatorial optimization problem by a simulated annealing method, the first processing means 130 is realized by the simulated annealing machine described above. The first processing means 130 realized by the simulated annealing machine can solve the combinatorial optimization problem described in Ising model form or QUBO form.

If the energy function shown in Equation (1) is given, the first processing means 130 finds the optimal individual spin state (1 or −1) in solving the combinatorial optimization problem. If the energy function shown in Equation (2) is given, the first processing means 130 finds the optimal individual spin state (1 or 0) in solving the combinatorial optimization problem. The optimal individual spin states obtained by the first processing means 130 represent the solution to the combinatorial optimization problem.

In the case where the combinatorial optimization problem is solved by a quantum annealing method, the first processing means 130 is realized by the quantum annealing machine described above. The first processing means 130 realized by the quantum annealing machine can solve the combinatorial optimization problem described in the form of a transverse magnetic field Ising model.

When the combinatorial optimization problem is a minimization problem, the optimal individual spin states are those in which the energy indicated by the energy function is as small as possible. When the combinatorial optimization problem is a maximization problem, the optimal individual spin states are those in which the energy indicated by the energy function is as large as possible.

As shown in FIG. 1, the first processing means 130 takes a combinatorial optimization problem as an input and the solution and the minimum or maximum value of the combinatorial optimization problem as outputs. If the combinatorial optimization problem is a minimization problem, the first processing means 130 outputs the minimum value. If the combinatorial optimization problem is a maximization problem, the first processing means 130 outputs the maximum value. The solution to the combinatorial optimization problem is the combination of values of the variables that yields the minimum or maximum value.

The second processing means 140 has the function of calculating the lower bound of the minimization target in the minimization problem for a combinatorial optimization problem with relaxed complex constraints, if the combinatorial optimization problem is a minimization problem. The second processing means 140 has the function of calculating the upper bound of the maximization target in the maximization problem, if the combinatorial optimization problem is a maximization problem.

The lower bound calculated by the second processing means 140 is hereinafter also referred to simply as the “lower bound of the question”. The upper bound calculated by the second processing means 140 is also referred to simply as the “upper bound of the problem”. The second processing means 140 is realized, for example, by the integer programming solver described above.

The processing control means 120 has the function of relaxing the combinatorial optimization problem input from the interface 110. The processing control means 120 generates a relaxation problem from the combinatorial optimization problem by relaxing the constraints imposed on the combinatorial optimization problem.

Specifically, in order to relax the combinatorial optimization problem to an easy-to-solve problem, the processing control means 120 performs a conversion such as “changing all discrete variables to continuous variables,” “changing some discrete variables to continuous variables,” “delete some constraints” while leaving linear constraints.

For example, the lower bound of the relaxed combinatorial optimization problem is expected to be small than or equal to the value obtained when the true solution is substituted into the original combinatorial optimization problem. Also, the upper bound of the relaxed combinatorial optimization problem is expected to be larger than or equal to the value obtained when the true solution is substituted into the original combinatorial optimization problem. The processing control means 120 inputs the relaxed combinatorial optimization problem to the second processing means 140.

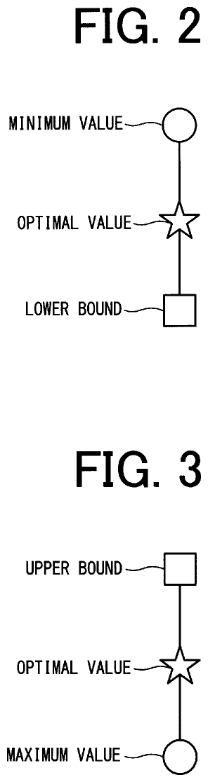

FIG. 2 is an explanatory diagram showing a size relationship between the minimum value, the optimal value, and the lower bound for the combinatorial optimization problem, which is a minimization problem.

The optimal value, represented by the star shown in FIG. 2, is the value obtained when the true solution in the minimization problem is substituted into the minimization problem. If the minimization problem is difficult to solve analytically, the optimal value is unknown.

The minimum value represented by the circle shown in FIG. 2 is the value obtained when the solution obtained from the minimization problem by the first processing means 130 is substituted into the minimization problem. The lower bound represented by the rectangle shown in FIG. 2 is the lower bound of the minimization problem obtained by the second processing means 140.

In general, the size relationship between the minimum value, the optimum value, and the lower bound in a combinatorial optimization problem, which is a minimization problem, is a relationship as shown in FIG. 2. Therefore, when the lower bound is obtained together with the minimum value of the combinatorial optimization problem, the user can roughly grasp the difference between the solution obtained by the first processing means 130 and the true solution better than when the lower bound is not obtained.

FIG. 3 is an explanatory diagram showing a size relationship between the maximum value, the optimal value, and the upper bound for the combinatorial optimization problem, which is a maximization problem.

The optimal value, represented by the star shown in FIG. 3, is the value obtained when the true solution in the maximization problem is substituted into the maximization problem. If the maximization problem is difficult to solve analytically, the optimal value is unknown.

The maximum value represented by the circle shown in FIG. 3 is the value obtained when the solution obtained from the maximization problem by the first processing means 130 is substituted into the maximization problem. The upper bound represented by the rectangle shown in FIG. 3 is the upper bound of the maximization problem obtained by the second processing means 140.

In general, the size relationship between the maximum value, the optimal value, and the upper bound in a combinatorial optimization problem, which is a maximization problem, is a relationship as shown in FIG. 3. Therefore, when the upper bound is obtained together with the maximum value of the combinatorial optimization problem, the user can roughly grasp the difference between the solution obtained by the first processing means 130 and the true solution better than when the upper bound is not obtained.

The processing control means 120 may divide the combinatorial optimization problem input from the interface 110 into multiple subproblems of a size that can be efficiently solved by the first processing means 130 and the second processing means 140. For example, the processing control means 120 may define a subproblem by substituting specific values to some variables.

As shown in FIG. 1, the interface 110 outputs the solution to the combinatorial optimization problem calculated by the first processing means 130 by solving the combinatorial optimization problem. The interface 110 outputs the value of the minimization target to which the solution to the combinatorial optimization problem, which is the minimization problem calculated by the first processing means 130, is substituted, or the value of the maximization target to which the solution to the combinatorial optimization problem, which is the maximization problem calculated by the first processing means 130, is substituted.

As shown in FIG. 1, the interface 110 outputs the lower bound or the upper bound calculated by the second processing means 140. The interface 110 outputs the lower bound of the minimization problem if the combinatorial optimization problem is a minimization problem and the upper bound of the maximization problem if the combinatorial optimization problem is a maximization problem together.

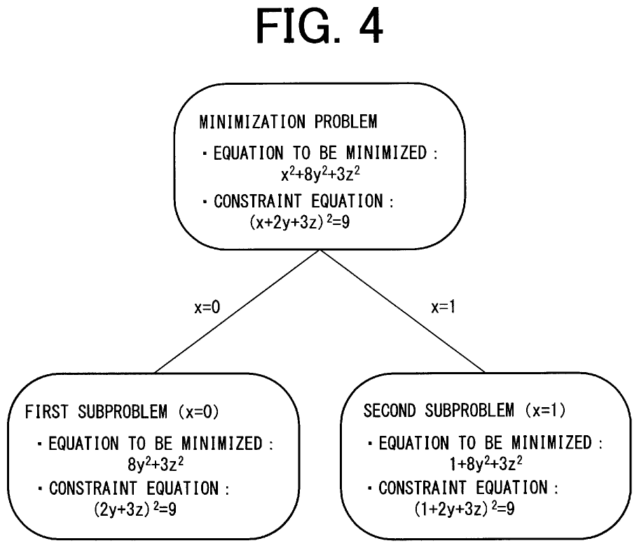

The examples that the solution accuracy guaranteeing annealing calculation device 100 solves the combinatorial optimization problem are explained below with reference to FIGS. 4-7. FIG. 4 is an explanatory diagram showing an example of dividing a combinatorial optimization problem by a processing control means 120.

The minimization problem shown in FIG. 4 is the combinatorial optimization problem to be solved in this example. The equation to be minimized in the minimization problem shown in FIG. 4 is “x²+8y²+3z²”. Also, the constraint equation imposed on the minimization problem is “(x+2y+3z)²=9”. The possible values of x, y, and z are “0” or “1”, respectively. In other words, the combinatorial optimization problem in this example is described in QUBO form.

In this example, first, the processing control means 120 defines two subproblems by substituting a specific value to the variable x. As shown in FIG. 4, the processing control means 120 defines the first subproblem by substituting “0” to x. The equation to be minimized in the first subproblem is “8y²+3z²”. The constraint equation imposed on the first subproblem is “(2y+3z)²=9”.

By substituting “1” to x, as shown in FIG. 4, the processing control means 120 defines the second subproblem. The equation to be minimized in the second subproblem is “1+8y²+3z²”. The constraint equation imposed on the second subproblem is “(1+2y+3z)²=9”.

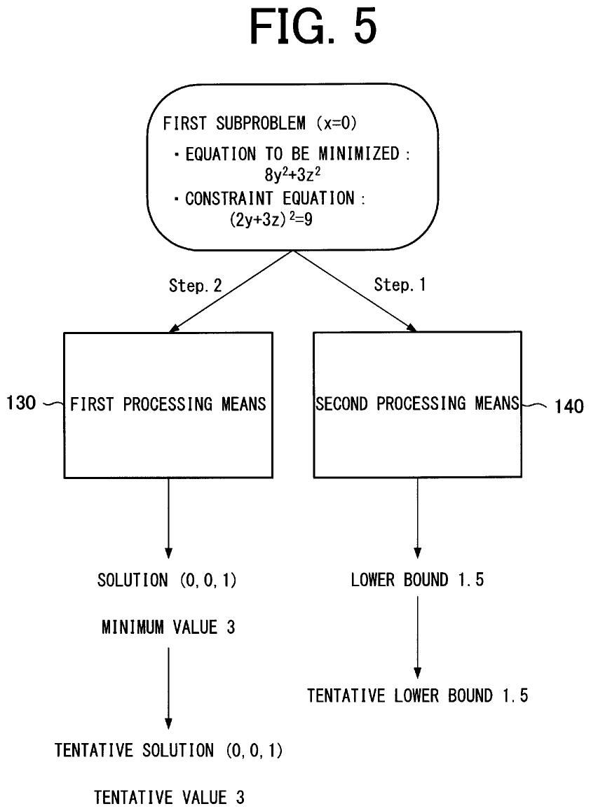

FIG. 5 is an explanatory diagram showing an example of solving a first subproblem by a first processing means 130 and a second processing means 140. First, the processing control means 120 converts y and z, both discrete variables, into continuous variables in order to relax the first subproblem into an easy-to-solve problem.

The second processing means 140 then finds the lower bound for the relaxed first subproblem (Step.1 shown in FIG. 5). If y and z are both converted to continuous variables as described above, the second processing means 140 can, for example, use differentiation to find the lower bound.

In Step.1 shown in FIG. 5, suppose that the second processing means 140 finds “1.5” as the lower bound. Since the first subproblem is the first problem to be solved, the lower bound found becomes the tentative lower bound as it is.

The first processing means 130 then finds the solution and the minimum value of the first subproblem (Step. 2 shown in FIG. 5). In Step. 2 shown in FIG. 5, suppose that the first processing means 130 finds (x,y,z)=(0,0,1) as the solution and “3” as the minimum value, respectively. Since the first subproblem is the first problem to be solved, the solution found is the tentative solution as it is, and the minimum value found is the tentative value as it is.

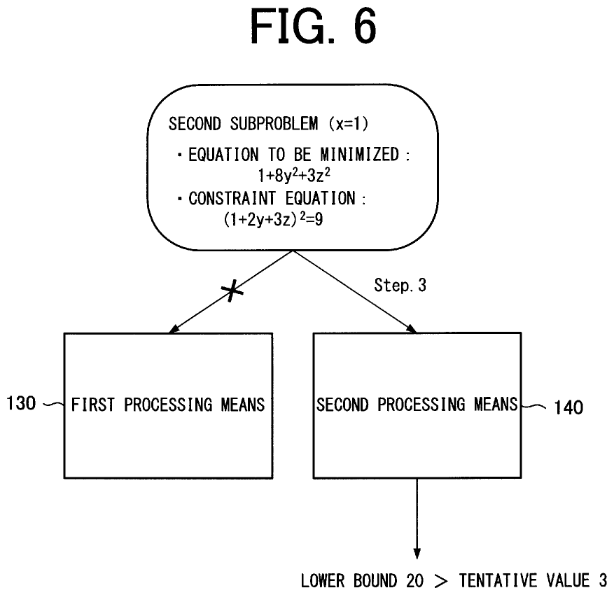

FIG. 6 is an explanatory diagram showing an example of solving a second subproblem by the first processing means 130 and the second processing means 140. First, the processing control means 120 converts y and z, both discrete variables, into continuous variables in order to relax the second subproblem into an easy-to-solve problem.

The second processing means 140 then finds the lower bound for the relaxed second subproblem (Step. 3 shown in FIG. 6). In Step. 3 shown in FIG. 6, suppose that the second processing means 140 finds “20” as the lower bound.

The lower bound “20” found in Step. 3 shown in FIG. 6 is larger than the tentative value “3”. In other words, even if the first processing means 130 finds the minimum value of the second subproblem, it is expected to find a value larger than the tentative value “3”. Therefore, the process of finding the solution and the minimum value of the second subproblem is a useless process, so the first processing means 130 stops the process of finding the solution and the minimum value of the second subproblem.

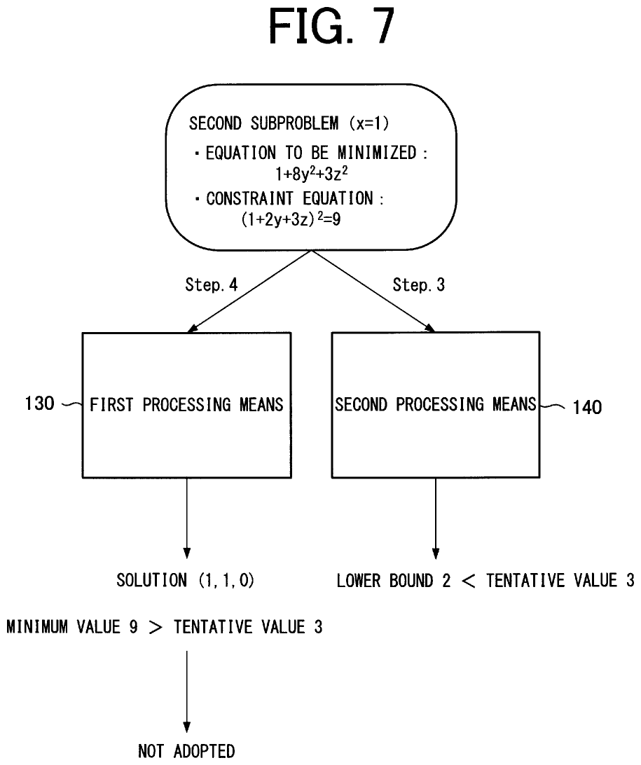

FIG. 7 is an explanatory diagram showing another example of solving the second subproblem by the first processing means 130 and the second processing means 140. First, the processing control means 120 converts y and z, both discrete variables, into continuous variables in order to relax the second subproblem into an easy-to-solve problem.

The second processing means 140 then finds the lower bound for the relaxed second subproblem (Step. 3 shown in FIG. 7). In Step. 3 shown in FIG. 7, suppose that the second processing means 140 finds “2” as the lower bound.

The lower bound “2” found in Step. 3 shown in FIG. 7 is smaller than the tentative value “3”. In other words, even if the first processing means 130 finds the minimum value for the second subproblem, it is expected to be a possibility to find a value smaller than the tentative value “3”.

The first processing means 130 then finds the solution and the minimum value of the second subproblem (Step. 4 shown in FIG. 7). In Step. 4 shown in FIG. 7, suppose that the first processing means 130 finds (x,y,z)=(1,1,0) as the solution and “9” as the minimum value, respectively.

The minimum value “9” found in Step. 4 shown in FIG. 7 is larger than the tentative value “3”. In other words, since the solution found in Step. 4 shown in FIG. 7 is not the optimal solution, the first processing means 130 does not adopt the solution found in Step. 4 shown in FIG. 7.

At the end of the process shown in FIG. 7, the tentative lower bound is “1.5”, the tentative solution is “(0,0,1)”, and the tentative value is “3”. Therefore, the interface 110 outputs the solution “(0,0,1)”, the minimum value “3”, and the lower bound “1.5” for the input combinatorial optimization problem, which is the minimization problem, respectively.

As described above, the solution accuracy guaranteeing annealing calculation device 100 of this example embodiment includes the first processing means 130 which solves the combinatorial optimization problem by the annealing method, and the second processing means 140 solves the relaxation problem, which is the problem generated by relaxing the constraints imposed on the combinatorial optimization problem.

If the combinatorial optimization problem is the minimization problem, the second processing means 140 calculates the lower bound of the minimization target in the minimization problem by solving the relaxation problem generated from the combinatorial optimization problem. If the combinatorial optimization problem is the maximization problem, the second processing means 140 calculates the upper bound of the maximization target in the maximization problem by solving the relaxation problem generated from the combinatorial optimization problem.

[Description of Operation]

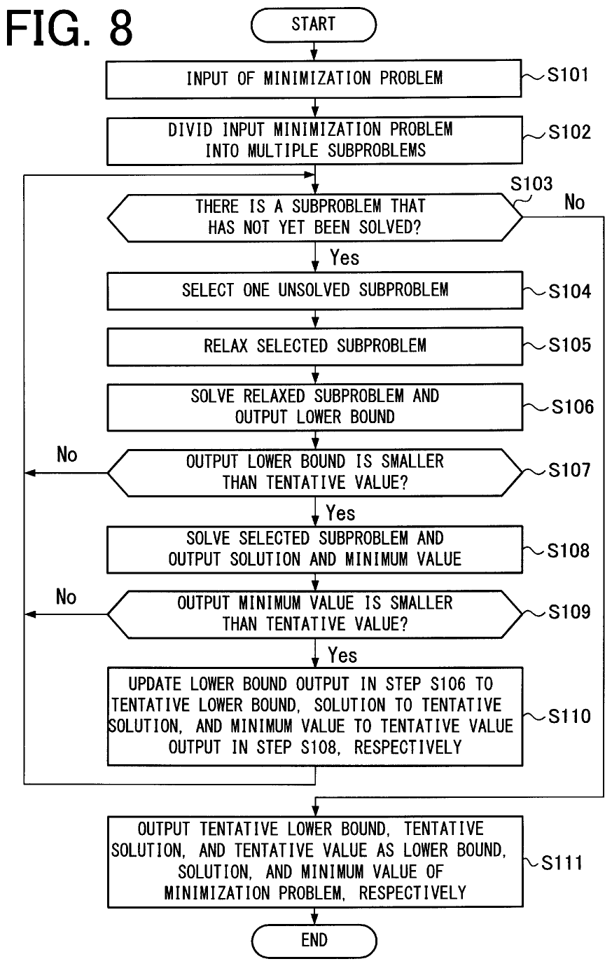

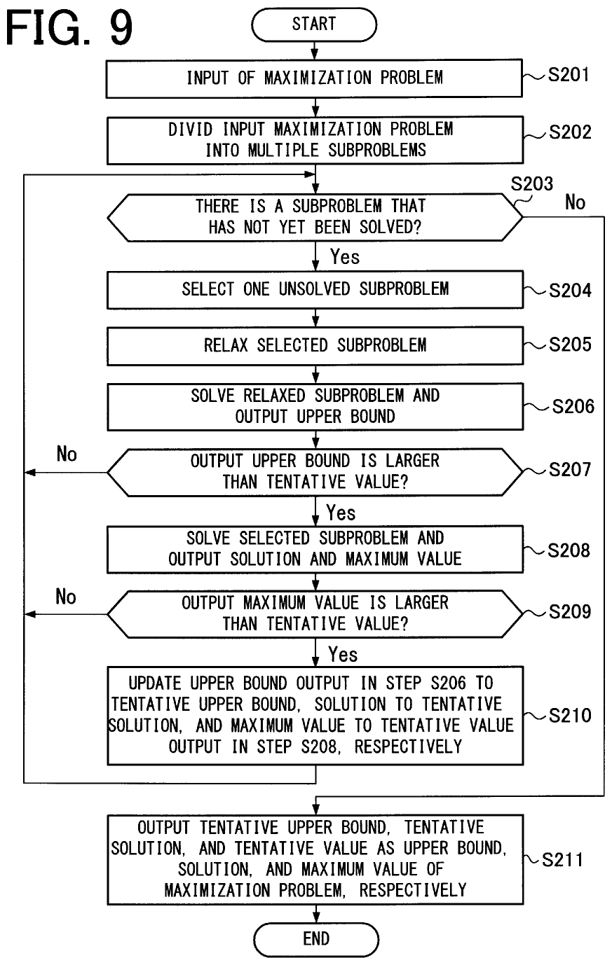

Hereinafter, the operation of the solution accuracy guaranteeing annealing calculation device 100 of this example embodiment will be described with reference to FIGS. 8-9. FIG. 8 is a flowchart showing an operation of the minimization problem solving process by the solution accuracy guaranteeing annealing calculation device 100 of this example embodiment. Note that no values are set for the tentative value, the tentative solution, and the tentative lower bound at the time the process is started.

First, a minimization problem is input as a combinatorial optimization problem to the interface 110 of the solution accuracy guaranteeing annealing calculation device 100 (Step S101).

Next, the processing control means 120 divides the minimization problem input to the interface 110 into multiple subproblems (Step S102). The processing of Step S102 may be omitted.

Next, the processing control means 120 checks whether or not there is a subproblem that has not yet been solved (Step S103). If the processing of Step S102 is omitted, the “subproblem” becomes “one minimization problem” (the same applies to the following steps).

If there is an unsolved subproblem (Yes in Step S103), the processing control means 120 selects one unsolved subproblem (Step S104).

Next, the processing control means 120 relaxes the selected subproblem (Step S105), and inputs the relaxed subproblem to the second processing means 140. The second processing means 140 then solves the relaxed subproblem and outputs the lower bound (Step S106).

Next, the processing control means 120 checks whether or not the output lower bound is smaller than the tentative value (Step S107). If the lower bound is larger than or equal to the tentative value (No in Step S107), the processing control means 120 terminates the solving of the selected subproblem and returns to Step S103.

If the lower bound is smaller than the tentative value (Yes in Step S107), the processing control means 120 inputs the selected subproblem to the first processing means 130. The first processing means 130 solves the selected subproblem and outputs the solution and the minimum value of the subproblem (Step S108).

Next, the processing control means 120 checks whether or not the output minimum value is small than the tentative value (Step S109). If the minimum value is larger than or equal to the tentative value (No in Step S109), the processing control means 120 returns to Step S103.

If the minimum value is smaller than the tentative value (Yes in Step S109), the processing control means 120 updates the lower bound output in Step S106 to the tentative lower bound, the solution to the tentative solution, and the minimum value to the tentative value output in Step S108, respectively (Step S110). After updating, the processing control means 120 returns to Step S103.

If there is no unsolved subproblem (No in Step S103), the interface 110 outputs the tentative lower bound, the tentative solution, and the tentative value as the lower bound, the solution, and the minimum value of the minimization problem, respectively (Step S111). After the output, the solution accuracy guaranteeing annealing calculation device 100 terminates the minimization problem solving process.

FIG. 9 is a flowchart showing an operation of the maximization problem solving process by the solution accuracy guaranteeing annealing calculation device 100 of this example embodiment. Note that no values are set for the tentative value, the tentative solution, and the tentative upper bound at the time the process is started.

First, a maximization problem is input as a combinatorial optimization problem to the interface 110 of the solution accuracy guaranteeing annealing calculation device 100 (Step S201).

Next, the processing control means 120 divides the maximization problem input to the interface 110 into multiple subproblems (Step S202). The processing of Step S202 may be omitted.

Next, the processing control means 120 checks whether or not there is a subproblem that has not yet been solved (Step S203). If the processing of Step S202 is omitted, the “subproblem” becomes “one maximization problem” (the same applies to the following steps).

If there is an unsolved subproblem (Yes in Step S203), the processing control means 120 selects one unsolved subproblem (Step S204).

Next, the processing control means 120 relaxes the selected subproblem (Step S205), and inputs the relaxed subproblem to the second processing means 140. The second processing means 140 then solves the relaxed subproblem and outputs the upper bound (Step S206).

Next, the processing control means 120 checks whether or not the output upper bound is larger than the tentative value (Step S207). If the upper bound is smaller than or equal to the tentative value (No in Step S207), the processing control means 120 terminates the solving of the selected subproblem and returns to Step S203.

If the upper bound is larger than the tentative value (Yes in Step S207), the processing control means 120 inputs the selected subproblem to the first processing means 130. The first processing means 130 solves the selected subproblem and outputs the solution and the maximum value of the subproblem (Step S208).

Next, the processing control means 120 checks whether or not the output maximum value is larger than the tentative value (Step S209). If the maximum value is smaller than or equal to the tentative value (No in Step S209), the processing control means 120 returns to Step S203.

If the maximum value is larger than the tentative value (Yes in Step S209), the processing control means 120 updates the upper bound output in Step S206 to the tentative upper bound, the solution to the tentative solution, and the maximum value to the tentative value output in Step S208, respectively (Step S210). After updating, the processing control means 120 returns to Step S203.

If there is no unsolved subproblem (No in Step S203), the interface 110 outputs the tentative upper bound, the tentative solution, and the tentative value as the upper bound, the solution, and the maximum value of the maximization problem, respectively (Step S211). After the output, the solution accuracy guaranteeing annealing calculation device 100 terminates the maximization problem solving process.

[Description of Effect]

The solution accuracy guaranteeing annealing calculation device 100 of this example embodiment includes a first processing means 130 which finds a solution to a combinatorial optimization problem in a state on which complex constraints are imposed and a second processing means 140 which finds a lower bound or an upper bound of the combinatorial optimization problem in a state where the imposed complex constraints are relaxed.

With the above configuration, when the combinatorial optimization problem is a minimization problem, the solution accuracy guaranteeing annealing calculation device 100 can output the lower bound of the minimization problem together with the solution. Also, when the combinatorial optimization problem is a maximization problem, the solution accuracy guaranteeing annealing calculation device 100 can output the upper bound and the solution to the maximization problem together.

Thus, the user who requests a solution to a combinatorial optimization problem can roughly grasp the difference between the obtained solution and the true solution, compared to the case where no lower bound or upper bound is obtained. In other words, the solution accuracy guaranteeing annealing calculation device 100 can guarantee the accuracy of the solution to the output combinatorial optimization problem.

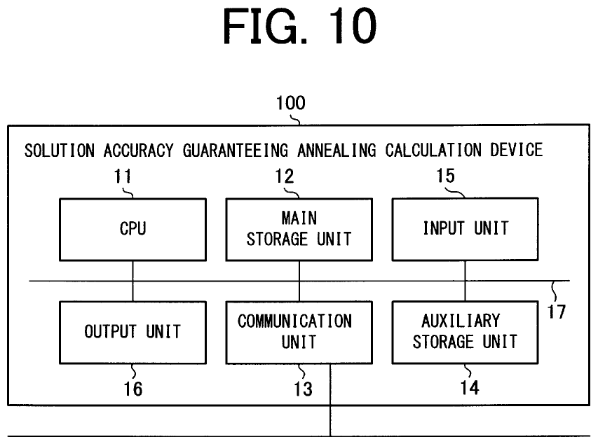

A specific example of a hardware configuration of the solution accuracy guaranteeing annealing calculation device 100 according to this example embodiment will be described below. FIG. 10 is an explanatory diagram showing an example of a hardware configuration of the solution accuracy guaranteeing annealing calculation device 100 according to the present invention.

The solution accuracy guaranteeing annealing calculation device 100 shown in FIG. 10 includes a CPU (Central Processing Unit) 11, a main storage unit 12, a communication unit 13, and an auxiliary storage unit 14. The solution accuracy guaranteeing annealing calculation device 100 also includes an input unit 15 for the user to operate and an output unit 16 for presenting a processing result or a progress of the processing contents to the user.

The solution accuracy guaranteeing annealing calculation device 100 is realized by software, with the CPU 11 shown in FIG. 10 executing a program that provides a function that each component has.

Specifically, each function is realized by software as the CPU 11 loads the program stored in the auxiliary storage unit 14 into the main storage unit 12 and executes it to control the operation of the solution accuracy guaranteeing annealing calculation device 100.

The solution accuracy guaranteeing annealing calculation device 100 shown in FIG. 10 may include a DSP (Digital Signal Processor) instead of the CPU 11. Alternatively, the solution accuracy guaranteeing annealing calculation device 100 shown in FIG. 10 may include both the CPU 11 and the DSP.

The main storage unit 12 is used as a work area for data and a temporary save area for data. The main storage unit 12 is, for example, RAM (Random Access Memory).

The communication unit 13 has a function of inputting and outputting data to and from peripheral devices through a wired network or a wireless network (information communication network).

The auxiliary storage unit 14 is a non-transitory tangible medium. Examples of non-transitory tangible media are, for example, a magnetic disk, an optical magnetic disk, a CD-ROM (Compact Disk Read Only Memory), a DVD-ROM (Digital Versatile Disk Read Only Memory), a semiconductor memory.

The input unit 15 has a function of inputting data and processing instructions. The output unit 16 has a function to output data. The interface 110 of this example embodiment is realized by the input unit 15 and the output unit 16.

As shown in FIG. 10, in the solution accuracy guaranteeing annealing calculation device 100, each component is connected to the system bus 17.

The auxiliary storage unit 14 stores programs for realizing the processing control means 120, the first processing means 130, and the second processing means 140 in the solution accuracy guaranteeing annealing calculation device 100 of this example embodiment.

The solution accuracy guaranteeing annealing calculation device 100 may be implemented with a circuit that contains hardware components inside such as an LSI (Large Scale Integration) that realize the functions shown in FIG. 1, for example.

The solution accuracy guaranteeing annealing calculation device 100 may be realized by hardware that does not include computer functions using elements such as a CPU. For example, some or all of the components may be realized by a general-purpose circuit (circuitry) or a dedicated circuit, a processor, or a combination of these. They may be configured by a single chip (for example, the LSI described above) or by multiple chips connected via a bus. Some or all of the components may be realized by a combination of the above-mentioned circuit, etc. and a program.

The first processing means 130 of the solution accuracy guaranteeing annealing calculation device 100 may be realized by an optical device or quantum device that solves the combinatorial optimization problem by the annealing method.

In the case where some or all of the components are realized by a plurality of information processing devices, circuits, or the like, the plurality of information processing devices, circuits, or the like may be centrally located or distributed. For example, the information processing devices, circuits, etc. may be realized as a client-server system, a cloud computing system, etc., each of which is connected via a communication network.

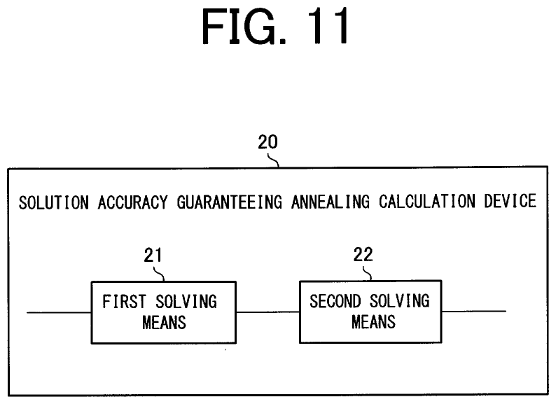

Next, an overview of the present invention will be described. FIG. 11 is a block diagram showing an overview of a solution accuracy guaranteeing annealing calculation device according to the present invention. The solution accuracy guaranteeing annealing calculation device 20 according to the present invention includes a first solving means 21 (for example, the first processing means 130) which solves a combinatorial optimization problem by an annealing method, and a second solving means 22 (for example, the second processing means 140) which solves a relaxation problem, which is a problem generated by relaxing constraints imposed on the combinatorial optimization problem, wherein the second solving means 22 calculates, if the combinatorial optimization problem is a minimization problem, a lower bound of a minimization target in the minimization problem by solving the relaxation problem generated from the combinatorial optimization problem, and calculates, if the combinatorial optimization problem is a maximization problem, an upper bound of a maximization target in the maximization problem by solving the relaxation problem generated from the combinatorial optimization problem.

With such a configuration, the solution accuracy guaranteeing annealing calculation device can guarantee the accuracy of solutions to combinatorial optimization problems.

The solution accuracy guaranteeing annealing calculation device 20 may include a generation means (for example, the processing control means 120) which generates a relaxation problem from the combinatorial optimization problem.

With such a configuration, the solution accuracy guaranteeing annealing calculation device can generate relaxation problems.

The generation means may output a solution to the combinatorial optimization problem calculated by the first solving means 21 by solving the combinatorial optimization problem, and the lower bound or the upper bound calculated by the second solving means 22.

The generation means may output a value of the minimization target to which the solution to the combinatorial optimization problem, which is the minimization problem calculated by the first solving means 21, is substituted, or a value of the maximization target to which the solution to the combinatorial optimization problem, which is the maximization problem calculated by the first solving means 21, is substituted.

With such a configuration, the solution accuracy guaranteeing annealing calculation device can output the solution, the minimum value or the maximum value, and the lower bound or the upper bound of the combinatorial optimization problem.

The combinatorial optimization problem may be a problem described in Ising model form.

With such a configuration, the solution accuracy guaranteeing annealing calculation device can solve a combinatorial optimization problem whose solution is a combination of “1” and “−1”.

The combinatorial optimization problem may be a problem described in QUBO form.

With such a configuration, the solution accuracy guaranteeing annealing calculation device can solve a combinatorial optimization problem whose solution is a combination of “1” and “0”.

The annealing method may be a simulated annealing method.

With such a configuration, the solution accuracy guaranteeing annealing calculation device can solve a combinatorial optimization problem using a simulated annealing machine.

The combinatorial optimization problem may be a problem described in transverse magnetic field Ising model form. The annealing method may be a quantum annealing method.

With such a configuration, the solution accuracy guaranteeing annealing calculation device can solve a combinatorial optimization problem using a quantum annealing machine.

### REFERENCE SIGNS LIST

11 CPU
12 Main storage unit
13 Communication unit
14 Auxiliary storage unit
15 Input unit
16 Output unit
17 System bus
20, 100 Solution accuracy guaranteeing annealing calculation device
21 First solving means
22 Second solving means
110 Interface
120 Processing control means
130 First processing means
140 Second processing means

What is claimed is:

1. A solution accuracy guaranteeing annealing calculation device comprising:
a memory configured to store instructions; and
a processor configured to execute the instructions to:
solve a combinatorial optimization problem by an annealing method;
solve a relaxation problem, which is a problem generated by relaxing constraints imposed on the combinatorial optimization problem;
calculate, if the combinatorial optimization problem is a minimization problem, a lower bound of a minimization target in the minimization problem by solving the relaxation problem generated from the combinatorial optimization problem; and
calculate, if the combinatorial optimization problem is a maximization problem, an upper bound of a maximization target in the maximization problem by solving the relaxation problem generated from the combinatorial optimization problem.

2. The solution accuracy guaranteeing annealing calculation device according to claim 1, wherein the processor is further configured to execute the instructions to:
generate a relaxation problem from the combinatorial optimization problem.

3. The solution accuracy guaranteeing annealing calculation device according to claim 2, wherein the processor is further configured to execute the instructions to:
output a solution to the calculated combinatorial optimization problem by solving the combinatorial optimization problem, and the calculated lower bound or the calculated upper bound.

4. The solution accuracy guaranteeing annealing calculation device according to claim 3, wherein the processor is further configured to execute the instructions to:
output a value of the minimization target to which the solution to the combinatorial optimization problem, which is the calculated minimization problem, is substituted, or a value of the maximization target to which the solution to the combinatorial optimization problem, which is the calculated maximization problem, is substituted.

5. The solution accuracy guaranteeing annealing calculation device according to claim 1, wherein
the combinatorial optimization problem is a problem described in Ising model form.

6. The solution accuracy guaranteeing annealing calculation device according to claim 1, wherein
the combinatorial optimization problem is a problem described in QUBO (Quadratic Unconstrained Binary Optimization) form.

7. The solution accuracy guaranteeing annealing calculation device according to claim 5, wherein
the annealing method is a simulated annealing method.

8. The solution accuracy guaranteeing annealing calculation device according to claim 1, to wherein
the combinatorial optimization problem is a problem described in transverse magnetic field Ising model form, and
the annealing method is a quantum annealing method.

9. A solution accuracy guaranteeing annealing calculation method comprising:
solving a combinatorial optimization problem by an annealing method;
solving a relaxation problem, which is a problem generated by relaxing constraints imposed on the combinatorial optimization problem;
calculating, if the combinatorial optimization problem is a minimization problem, a lower bound of a minimization target in the minimization problem by solving the relaxation problem generated from the combinatorial optimization problem; and
calculating, if the combinatorial optimization problem is a maximization problem, an upper bound of a maximization target in the maximization problem by solving the relaxation problem generated from the combinatorial optimization problem.

10. A non-transitory computer-readable recording medium recording a solution accuracy guaranteeing annealing calculation program causing a computer to execute:
a first solving process of solving a combinatorial optimization problem by an annealing method; and
a second solving process of solving a relaxation problem, which is a problem generated by relaxing constraints imposed on the combinatorial optimization problem,
wherein the solution accuracy guaranteeing annealing calculation program causes the computer to calculate, if the combinatorial optimization problem is a minimization problem, a lower bound of a minimization target in the minimization problem by solving the relaxation problem generated from the combinatorial optimization problem, and calculate, if the combinatorial optimization problem is a maximization problem, an upper bound of a maximization target in the maximization problem by solving the relaxation problem generated from the combinatorial optimization problem, in the second solving process.
